(19) United States
(12) Patent Application Publication
(10) Pub. No.: US 2015/0050465 A1
(43) Pub. Date: Feb. 19, 2015

(54) System and Method for Reducing Lumber Misuse in Construction

(71) Applicant: Color Plan Ink, LLC, Sugar Land, TX (US)

(72) Inventor: Dewey William Hennessee, Sugar Land, TX (US)

(21) Appl. No.: 13/969,589

(22) Filed: Aug. 18, 2013

(51) Int. Cl. E04C 2/12; G06Q 50/08; G06Q 10/08

(52) U.S. Cl. CPC E04C 2/12; G06Q 10/087; G06Q 50/08
USPC 428/195.1; 427/256; 427/8

(57) ABSTRACT

A system and method for reducing lumber misuse is disclosed. Specifically, a system can comprise lumber marked according to a coded chart. The chart can comprise one or more attributes associated with the lumber. The lumber can also comprise a plurality of identifiers, each of the identifiers associated with at least one of the attributes. The method for reducing lumber misuse can comprise marking lumber with a plurality of unique identifiers, said identifiers associated to one or more attributes.

### BACKGROUND

This disclosure relates to a system and method for reducing lumber misuse in construction. For purposes of this disclosure, embodiments are discussed, and are an example of the system and method. However, such discussion is solely exemplary, and not limiting.

In the push for affordable housing, various methods for reducing construction costs have evolved. New materials have been developed, methods of construction have improved, and waste of materials has been reduced. However, lumber waste in construction of homes and other structures still remains a serious issue. During construction of a home, lumber is delivered in one or more large shipments. Such shipment or shipments can contain varieties of lumber. Differences in lumber can include, but is not limited to, type of wood, treatments, cross sectional dimension, lengths, and/or grade. A major variance in new home construction is the initial frame state. Material misuse and take off error is costly and difficult to track. For example, a home may need ten 2×10's, fourteen feet long for a particular portion of a building. An efficient shipment, to accommodate construction, would include only ten such pieces of lumber. However, if during construction, a carpenter cuts a fourteen foot 2×10 into pieces for a different portion of the house, then the builder will be short of lumber when the 14 foot piece is needed later. As another example, suppose a carpenter accidentally uses a 2×6 during construction where a 2×8 is required. If noticed during inspection, the work would have to be dismantled and rebuilt. If not noticed, such difference could cause a safety hazard.

It is believed that lumber misuse raises the price of a new home construction by more than $350. Reduction in waste by this amount could save builders in the State of Texas by $56 million dollars each year. However, such costs are not the only benefit. Reducing lumber waste reduces landfill space, saves trees, and reduces short orders and the clerical time, fuel, added construction time, and additional lumber company infrastructure needed to facilitate short orders.

As such it would be useful to have an improved system and method for reducing lumber misuse in construction.

### SUMMARY

A system and method for reducing lumber misuse is disclosed. Specifically, a system can comprise lumber marked according to a coded chart. The chart can comprise one or more attributes associated with the lumber. The lumber can also comprise a plurality of identifiers, each of the identifiers associated with at least one of the attributes. The method for reducing lumber misuse can comprise marking lumber with a plurality of unique identifiers, said identifiers associated to one or more attributes.

### BRIEF DESCRIPTION OF THE DRAWINGS

FIG. 1 illustrates a coded chart.

FIG. 2 illustrates a printed text embodiment for identifying a lumber.

FIG. 3 illustrates a color line embodiment for identifying lumber.

FIG. 4 illustrates a line type embodiment for identifying lumber.

FIG. 5 illustrates a frame plan that employs color-coded lumber system.

### DETAILED DESCRIPTION

Described herein is a system and method for reducing lumber misuse in construction. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

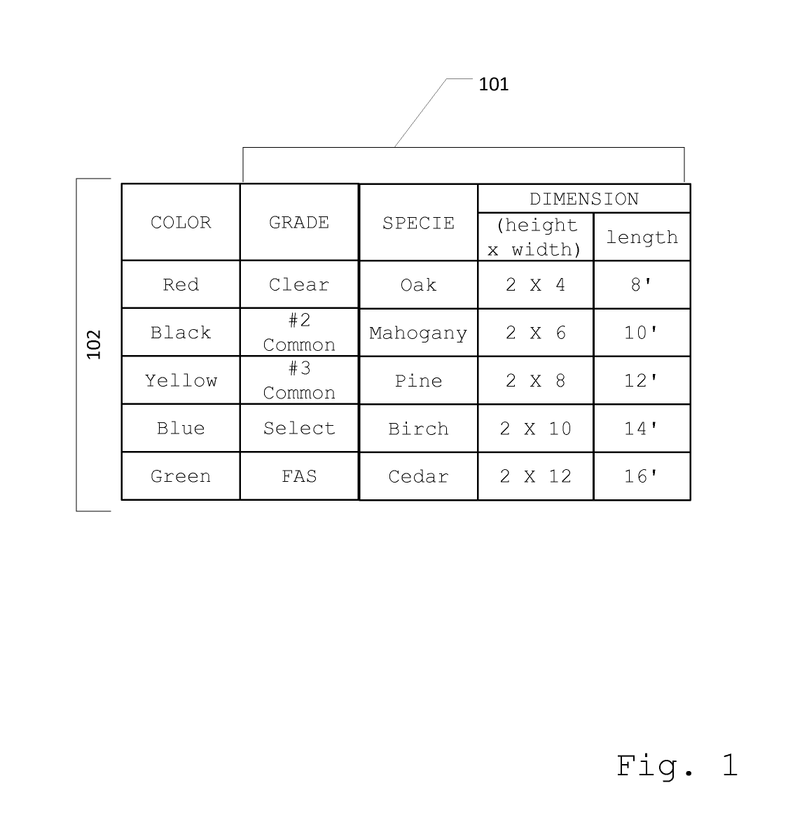

FIG. 1 illustrates a coded chart 100. For purposes of this disclosure, coded chart 100 can represent different wood attributes applicable to a lumber. Coded chart 100 can only be an example chart that represents a possible master list of a color-coded dimensional lumber system. Thus, other attributes and color can be used for color-coded lumber system. Color scheme chart 100 can comprise a plurality of attributes 101, and identifier 102. Attributes 101 can be classifications and identification of woods that can include but are not limited to lumber grade, lumber treatment, lumber specie, dimensional length, and dimensional width and height. Wood grades can be the range of appearance and quality of lumber with respect to natural characteristics of wood such as knots, slope of grain, wane, manufacturing defects, and warp. Treatment can be the preservation measures applied to wood to increase durability and extend life of the material. Specie can be the source of lumber that pertains to the biological classification of wood. Dimensional width and length can be the size and measurement of lumber. Identifier 102 can be the visual representation of each attributes 101. Identifier 102 can be applied to a lumber in a form of text, symbols, colors, line types, and other graphical representation to provide a standard identification for construction lumbers. Moreover, identifier 102 can be applied on a lumber through various marking methods that include but are not limited to printing, embossing, or engravings.

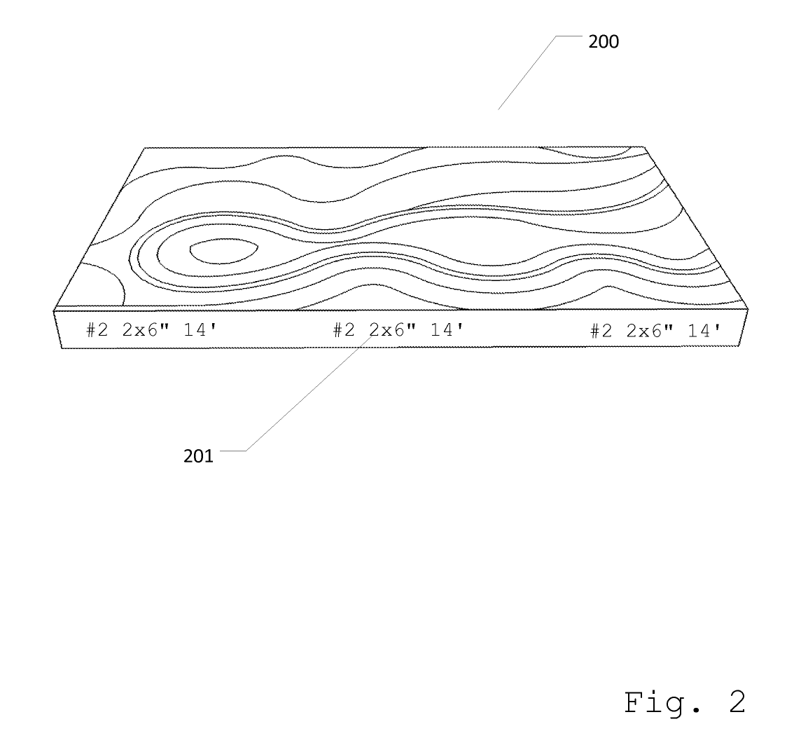

FIG. 2 illustrates a printed text embodiment for identifying a lumber 200. For purposes of this disclosure, lumber 200 can be any type of wood having different attributes. Lumber 200 are generally used in the construction industry for structural purposes. As such, lumber 200 can have standard characteristics and dimension to fit the needs or requirements for a certain structure. In this embodiment, each lumber 200 can be classified by using printed text 201. Printed text 201 can be an alphanumeric identifier 102 that are placed at one or more surfaces of lumber 200. Printed text 201 can comprise a standard lumber attribute 101 such as wood grade, dimension, length, and wood specie as an example. In one embodiment, printed text 201 of lumber 200 can be written in one particular color. Thus, can represent one specific quality. As one example through using coded chart 100 as a guide, if color is used as an identifier 102 to represent lumber treatment attribute then printed text 201 written in “red” can mean that lumber 200 can be a treated lumber and a color “black” can be synonymous to untreated lumber. Therefore, printed text written in red, this can indicate that lumber 200 can be a treated grade 2 lumber having a width and height of 2 inches by 6 inches and a length of 14 foot. Similarly, printed text 201 written in black can indicate that lumber 200 can an untreated grade 2 lumber having a width and height of 2 inches by 6 inches and a length of 14 foot. As another example a color as an identifier 102 can also be used to indicate species of wood. Thus using coded chart 100, if printed text 201 in lumber 200 is written in yellow text, lumber 200 can be easily identified as made of pine wood or if printed text 201 is written in “red” then lumber 200 can be an oak wood.

In another embodiment, printed text 201 can be represented with two or more color. As example, printed text 201 can be written on lumber 200 as “2×6 14′”. In such example, each dimensional attribute can apply different color coding scheme. As such, the height and width attribute can employ wood treatment color scheme while the length attribute can make use of wood specie color scheme. Thus, using coded chart 100, if “2×6” is written in black and “14′” is written in yellow, then this can imply that lumber 200 can be an untreated pine wood having a width and height of 2 inches by 6 inches and a length of 14 foot.

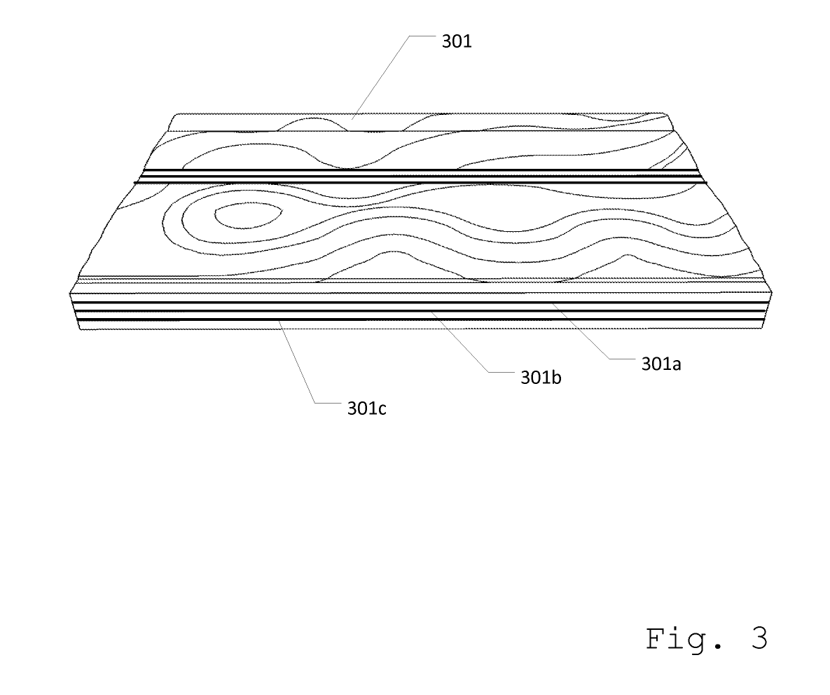

FIG. 3 illustrates a color line embodiment for identifying lumber 200. In this embodiment, one or more colored lines 301 can be used to represent a specific attribute of lumber 200. As such, colored lines 301 can be used as identifier 102. In one embodiment colored lines 301 can be a colored solid line as illustrated in FIG. 3. As an example, line 301a can represent grade, line 301b can indicate height and width dimension, while line 301c can be the length dimension of lumber 200. Therefore, if line 301a is printed in “black”, line 301b is in “blue” and line 301c is painted in red, then lumber 200 can be a grade 2 lumber having the dimension of 2 inches by 10 inches and length of 8 feet. Furthermore, colored lines 301 can be printed on lumber 200 in various ways such as vertically, horizontally, or diagonally. Moreover in this embodiment, line 301a can be identified as an index line to ensure that each attributes 101 are identified correctly. Index line can be used as a guide and reference in knowing which of the lines are read first. As such, line 301a can have a different thickness in comparison to lines 301b and 301c, in one embodiment. In another embodiment, an image, text or symbol can be written beside the line 301a to identify line 301a as the index line. Further, in another embodiment, colored lines 301 can be a symbol or a shape that closely identifies a specific attribute of lumber 200. Such line or lines 301 can be placed on wood at a mill during or after a milling process. Marking at the mill can make the process of marking more efficient.

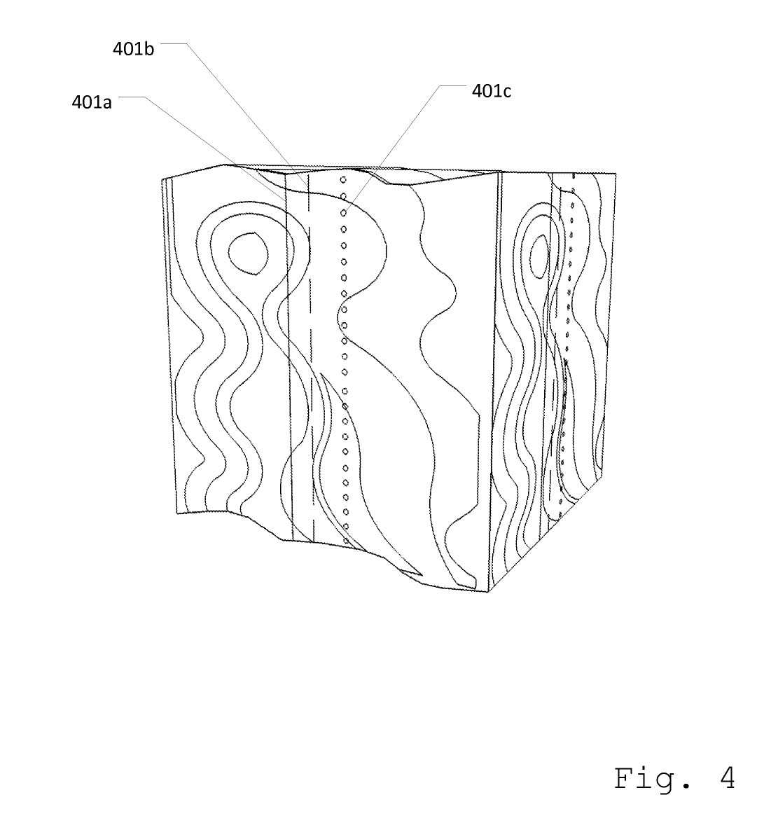

FIG. 4 illustrates a line type embodiment for identifying lumber 200. Each line types 401 can be a general representation of each attributes 101. Line types 401 can be different forms of line such as a solid line, dashed line, crooked line, or dotted line. Furthermore, line types 401 can be identifier 102. Line type 401a can also serve as an index line. Line types 401 can relate to an attribute of the wood as described above. For example, a dashed line can represent the type of wood, and the color of the dashed line can be a particular type. For example, an orange dashed line can represent oak, while a purple dashed line can represent pine. A solid line next to the dashed line can represent the original length of the wood. For example, a red solid line can be 10′, while an orange line can represent 12′. In another embodiment, a dotted line, for example, can represent the quality of wood.

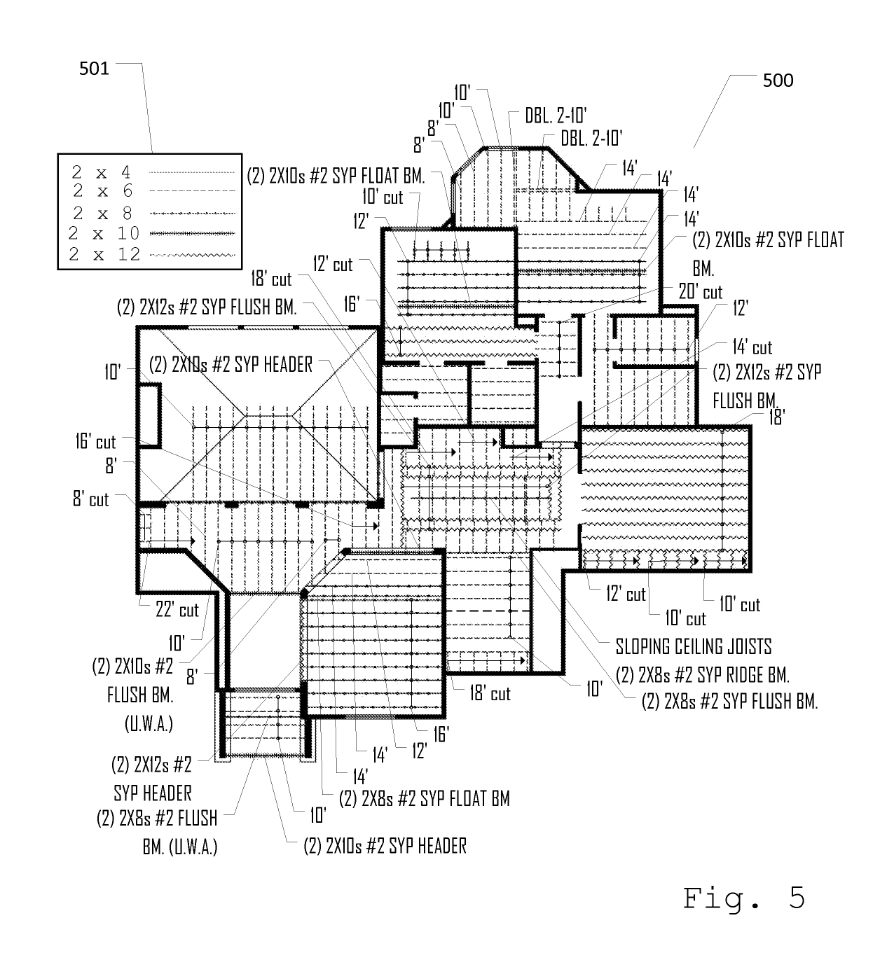

FIG. 5 illustrates a frame plan 500 that employs color-coded lumber system. Frame plan 500 can be a diagram of lumber arrangement for structural framing. Color-coded lumber system can enable anyone to easily and accurately determine attributes 101 of lumber 200 that are used in every area. Legends 501 can be represented in line type form (as illustrated in FIG. 5) or in colored form. For example, in an actual plan, the dashed line could be replaced by the color orange. For the sake of patent office regulations on drawings, line types are being used to represent colors so that drawings can be submitted in black and white. In this example, dimensional height and width attribute is used to represent each lumber 200 seen in frame plan 500. Dimensional height and width attribute can be classified in 5 sizes which are “2×4”, “2×6”, “2×8”, “2×10”, and “2×12”. Therefore, in an embodiment line type 401 can be used, frame plan 500 can be as illustrated in FIG. 5 wherein five types of line types are used to indicated different sizes of lumber 200. As such, “2×4” can be represented by a solid line 501a, “2×6” can be represented as a dashed line 501b, “2×8” can be displayed as squared line 501c, “2×10” can be illustrated as stitched line 501d, and “2×12” can be displayed as crooked line 501e. Further, in an embodiment wherein colored lines or colored text can be used, each dimensional height and width can be represented in specific color. As such, “2×4” can be printed in orange, “2×6” can be illustrated in green, “2×8” can be displayed in yellow, “2×10” can be illustrated in blue, and “2×12” can be represented in magenta. Moreover these embodiments, as seen in frame plan 500 the dimensional lengths for each lumber 200 can be indicated in text. Through these embodiments, a quick look at frame plan 500 can help a person to easily identify the kind and quantity of lumber 200 that are mostly needed for a certain plan. Moreover, a lay person can easily compare the frame plan 500 with the actual project site to immediately identify any discrepancy.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for reducing lumber misuse comprising
lumber marked according to a coded chart, said chart comprising
one or more attributes, said attributes associated to a lumber; and
a plurality of identifier, each of said identifier associated with at least one of said attributes.

2. The system of claim 1 wherein said identifier can be applied to said lumber through a marking method.

3. The system of claim 1 wherein said attribute is a lumber grade.

4. The system of claim 1 wherein said lumber is marked on at least three sides.

5. The system of claim 1 wherein said attribute is lumber specie.

6. The system of claim 1 wherein said attribute is a dimensional length.

7. The system of claim 1 wherein said attribute is a dimensional width and height.

8. The system of claim 1 wherein said identifier is a text.

9. The system of claim 1 wherein said identifier is a color.

10. The system of claim 1 wherein said identifier is a line type.

11. A method for reducing lumber misuse comprising
marking a lumber with a plurality of unique identifiers, said identifiers associated to one or more attributes.

12. The method of claim 11 comprising printing said unique identifier on said lumber.

13. The method of claim 11, further comprising the step of using said identifiers to create a structural framing plan.

14. The method of claim 12, further comprising the step of comparing said identifiers on said structural framing plan with said lumber.
